(19) United States
(12) Patent Application Publication
(10) Pub. No.: US 2026/0241697 A1
(43) Pub. Date: Aug. 20, 2026

(54) LIQUID STORAGE CONTAINER

(71) Applicant: CANON KABUSHIKI KAISHA, Tokyo (JP)

(72) Inventors: TAKAYUKI NAKAJIMA, Kanagawa (JP); TAKETSUGU MURAKAMI, Kanagawa (JP)

(21) Appl. No.: 19/539,131

(22) Filed: Feb. 13, 2026

(30) Foreign Application Priority Data
Feb. 20, 2025 (JP) 2025-025869

(51) Int. Cl. B41J 2/175; B41J 2/14; B41J 2/165

(52) U.S. Cl. CPC B41J 2/17553; B41J 2/14; B41J 2/16532; B41J 2/17513; B41J 2/1752; B41J 2/17566

(57) ABSTRACT

Provided is a liquid storage container, including: a flexible liquid storage portion storing a liquid including a precipitation component; and a spout mounted in the liquid storage portion, in which the spout includes at least a first liquid suction port and a second liquid suction port, the center of the first liquid suction port and the center of the second liquid suction port are on the same center axis, the first liquid suction port opens in the opposite direction of a direction in which gravity works in the spout, the second liquid suction port opens in the direction in which the gravity works in the spout, and a relationship of A2≥A1 is satisfied, where an opening area of the first liquid suction port is A1, and an opening area of the second liquid suction port is A2.

### BACKGROUND

### Field of the Technology

The present disclosure relates to a liquid storage container used for a liquid ejection apparatus that ejects a liquid.

### Description of the Related Art

Conventionally, a liquid storage container configured to supply a liquid ejection apparatus with a liquid has been widely utilized.

Japanese Patent Laid-Open No. 2021-003865 (PTL 1) discloses a liquid storage container including a liquid storage portion that stores a liquid including a precipitation component. PTL 1 discloses a technique for the liquid storage container to supply a liquid at a uniform density even in a case where it is difficult to suck in the precipitation component at a high density on a lower side of the liquid storage container due to an increase in the viscosity of the stored liquid.

In a case where the liquid storage portion of the liquid storage container is flexible, and there is a demand for a high deaeration performance in the stored liquid, gas-liquid exchange is not performed as the liquid is consumed, and the liquid storage portion is crumpled gradually. In this case, if there is a structure inside the liquid storage portion, the liquid storage portion may not be sufficiently crumpled, and the liquid may remain in a space that is not crumpled.

Additionally, in a case where the liquid storage container is stocked or preserved, the component in the container may be precipitated, and the viscosity or the density of the liquid may be varied.

### SUMMARY

A liquid storage container of the present disclosure includes: a flexible liquid storage portion storing a liquid including a precipitation component; and a spout mounted in the liquid storage portion, in which the spout includes at least a first liquid suction port and a second liquid suction port, as for the first liquid suction port and the second liquid suction port, the center of the first liquid suction port and the center of the second liquid suction port are on the same center axis, the first liquid suction port opens in the opposite direction of a direction in which gravity works in the spout, the second liquid suction port opens in the direction in which the gravity works in the spout, and a relationship of A2≥A1 is satisfied, where an opening area of the first liquid suction port is A1, and an opening area of the second liquid suction port is A2.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a liquid ejection apparatus including a liquid storage container of the present disclosure;

FIG. 2 is a perspective view of the liquid storage container in a first embodiment;

FIG. 3 is an exploded perspective view of the liquid storage container in the first embodiment;

FIG. 4 is a perspective view of a spout in the first embodiment;

FIG. 5 is a cross-sectional view of the spout in the first embodiment;

FIG. 6 is a perspective view of the spout in a case where positions of liquid suction ports in the first embodiment are not aligned with each other in a Z-axis direction;

FIG. 7 is a cross-sectional view of the spout in a case where the positions of the liquid suction ports in the first embodiment are not aligned with each other in the Z-axis direction;

FIG. 8 is a diagram of a situation where a film forming a liquid storage portion is closely attached to the spout that is viewed from a −X direction;

FIG. 9 is a perspective view illustrating the spout formed of two components in the first embodiment;

FIG. 10 is a perspective view of the spout in a second embodiment;

FIG. 11 is a diagram of the spout in the second embodiment that is viewed from a −Y direction;

FIG. 12 is a diagram of the spout in the second embodiment that is viewed from a +Z direction; and

FIG. 13 is a perspective view illustrating the spout to which a filter can be bonded in the second embodiment.

### DESCRIPTION OF THE EMBODIMENTS

In a case of a configuration in which a liquid storage portion of a liquid storage container is flexible, and there is a demand for a high deaeration performance in a stored liquid, gas-liquid exchange is not performed as the liquid is consumed, and the liquid storage portion is crumpled gradually. In this case, if there is a structure inside the liquid storage portion, the liquid storage portion may not be sufficiently crumpled, and the liquid may remain in a space that is not crumpled. Therefore, in a case where the structure is provided inside the liquid storage portion, it is desirable for the structure to be as small as possible.

For example, in the liquid storage container (for example, the one described in PTL 1) in which three liquid channels extending in a horizontal direction need to be provided in the horizontal direction or a gravity direction, the structure inside the liquid storage portion is greater than necessary. For this reason, in the above-described liquid storage container, there is a possibility that a great amount of the liquid is not all used and left in a case of using up the liquid in the liquid storage container.

In addition, in a case where the liquid storage container is stocked or preserved, a component in the container may be precipitated, and the viscosity or the density of the liquid may be varied. In such a case, it is desirable for the viscosity and the density of the liquid to be maintained uniform in a case of supplying the liquid.

The present disclosure is made in view of the above-described points.

Hereinafter, embodiments of the present disclosure are described in detail with reference to the appended drawings. Note that, the following embodiments are not intended to limit the matters of the present disclosure. Additionally, a part of or all the characteristics described in the embodiments of the present disclosure can be combined, and not all the characteristics are essential for the present disclosure.

In the descriptions in the present specification, regarding the liquid storage container of the present disclosure, a direction may be defined by an X-axis, a Y-axis, and a Z-axis. These axes are each indicated by a directional axis that is illustrated in each drawing and provided with an arrow. In each axis, in a case where an axis direction is indicated by arrows in two directions, it means that an object moves in both the directions of “+” and “−” directions of the corresponding axis.

In the present specification, in a case of specifying the direction of each axis, the direction in which the arrow is directed in the axis of X, Y, or Z direction is defined as “+” direction of each axis. That is, in the direction of “+” or “−” of each axis, “+” direction is the direction in which the arrow is directed, and “-” direction is the opposite direction of the direction in which the arrow is directed. Additionally, in a case of mentioning the direction of the axis without specifying the direction of “+” or “−,” it is simply referred to as “X-axis direction,” “Y-axis direction,” or “Z-axis direction.”

In the present specification, terms “liquid” and “ink” are used. These terms in the present disclosure are used as a concept involving any liquid that can be used for recording. Additionally, “liquid” and “ink” mean an arbitrary liquid medium that may be used for formation of an image, processing of a recording medium, and the like by being applied to the recording medium. Accordingly, in the present specification, the terms “liquid” and “ink” (the word “ink” includes the word “ink W”) are used as words having compatible meanings.

### Liquid Ejection Apparatus

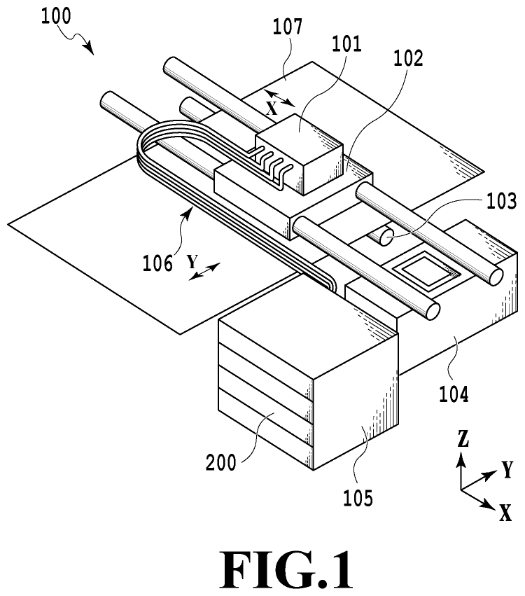

A liquid ejection apparatus using the liquid storage container of the present disclosure is described with reference to FIG. 1.

A liquid ejection apparatus 100 illustrated in FIG. 1 includes a liquid ejection head 101, a carriage 102, a conveyance roller 103, a recovery unit 104, a liquid supply unit 105, and a liquid supply tube 106. In the liquid ejection apparatus 100, one or more liquid storage containers of the present disclosure may be loaded in the liquid supply unit 105. Additionally, a recording sheet 107 as the recording medium is loaded in the liquid ejection apparatus 100.

The liquid ejection apparatus 100 illustrated in FIG. 1 repeats reciprocal movement of the liquid ejection head 101 [main scanning (the X-axis direction in FIG. 1)] and conveyance of the sheet 107 as the recording medium by a predetermined pitch [sub scanning (the Y-axis direction in FIG. 1)]. The liquid ejection apparatus 100 selectively ejects multiple colors of liquids from the liquid ejection head 101 in synchronization with the above-described movements and lands the liquids onto the sheet 107 as the recording medium to form a character, a sign, an image, and so on. Note that, any recording medium may be applied as long as it can be used for image formation, printing, and the like by landing a droplet of the liquid. For example, a variety of materials and forms such as paper, cloth, an optical disc label surface, a plastic sheet, an OHP sheet, an envelope, and various substrates can be used as the recording medium. In this case, in the present disclosure, the concept of recording is not limited to forming a character, a sign, an image, and so on and may also be applicable to industrial use and the like. For example, the concept of recording involves applications such as creating a biochip, printing an electronic circuit, and creating a semiconductor substrate.

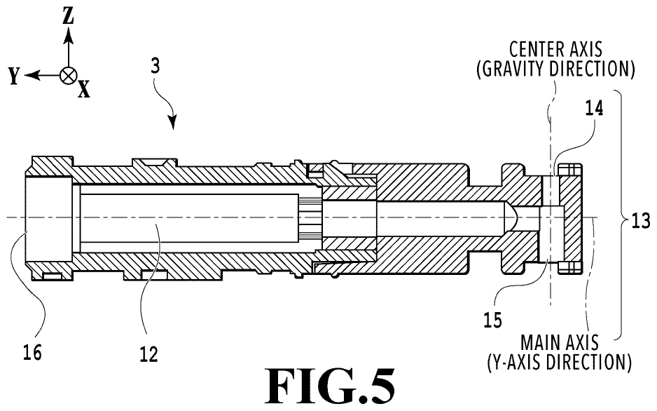

In FIG. 1, the liquid ejection head 101 is mounted detachably on the carriage 102 that is slidably supported by two guide rails and reciprocally moved straightly along the guide rails by a driving unit such as a not-illustrated motor. The conveyance roller 103 as a conveyance unit allows the recording sheet 107 that receives the liquid ejected from a liquid ejection unit of the liquid ejection head 101 to face a liquid ejection surface of the liquid ejection head 101. In addition, the recording sheet 107 is conveyed in a direction (the Y-axis direction in FIG. 1) crossing a movement direction (the X-axis direction in FIG. 1) of the carriage 102. The liquid ejection head 101 includes multiple nozzle arrays to eject different colors of liquids as multiple liquid ejection units, respectively. Corresponding to the colors of the liquids ejected from the liquid ejection head 101, multiple independent liquid storage containers 200 each including a liquid flow-through hole 12 (see FIG. 5 and the like) are detachably mounted in the liquid supply unit 105. The liquid supply unit 105 and the liquid ejection head 101 are connected by the multiple liquid supply tubes 106 that correspond to the multiple characteristics (for example, colors) of the liquids, respectively. With a user moving the liquid storage container forward to mount the liquid storage container in the liquid supply unit 105, it is possible to supply each liquid (for example, each color of ink) stored in the liquid storage container independently to each nozzle array of the liquid ejection head 101. Note that, the liquid supply unit 105 is equipped with a pump mechanism and can suck the liquid from the liquid storage container and transfer the liquid to a liquid ejection head 101 side.

In a non-recording region that is a region within a range of the reciprocal movement of the liquid ejection head 101 but outside a range where the recording sheet 107 passes through, the recovery unit 104 is arranged to face the liquid ejection surface of the liquid ejection head 101. The recovery unit 104 includes a cap unit to cap the liquid ejection surface of the liquid ejection head 101, a suction mechanism to forcibly suck the liquid while capping the liquid ejection port surface, a cleaning blade to wipe off contamination of the liquid ejection surface, and the like. The above-described suction operation is performed by the recovery unit 104 in advance of a recording operation performed by the liquid ejection apparatus. Thus, even in a case where the liquid ejection apparatus is operated after being left for a long period of time, the recovery processing performed by the recovery unit 104 makes it possible to eliminate a remaining air bubble in the ejection unit of the liquid ejection head 101, a thickened liquid (ink W) around the ejection port, and the like. Thus, the ejection characteristics of the liquid ejection head 101 are maintained.

Note that, in the present specification, a direction in which the liquid storage container 200 is mounted and detached in and from the liquid supply unit 105 is the Y-axis direction. A side on which the liquid storage container is mounted in the liquid supply unit 105 is a +Y direction. A width direction of the liquid storage container is the X-axis direction. Additionally, in the present specification, a height direction of the liquid storage container (that is, the gravity direction) is the Z-axis direction. A side of the Z-axis direction (the gravity direction) on which the gravity works (in the present specification, also referred to as a gravity side or a lower side) is a −Z direction, and the opposite side of the side of the Z-axis direction (the gravity direction) on which the gravity works (in the present specification, also referred to as an opposite-of-gravity side or an upper side) is a +Z direction.

Hereinafter, the liquid storage container of the present disclosure is described in detail with reference to the drawings.

### First Embodiment

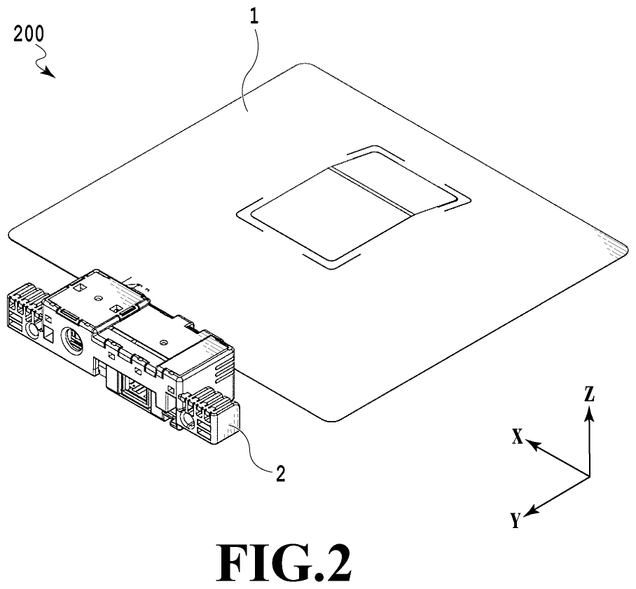

The liquid storage container 200 that is a first embodiment of the present disclosure is described with reference to FIGS. 2 to 9.

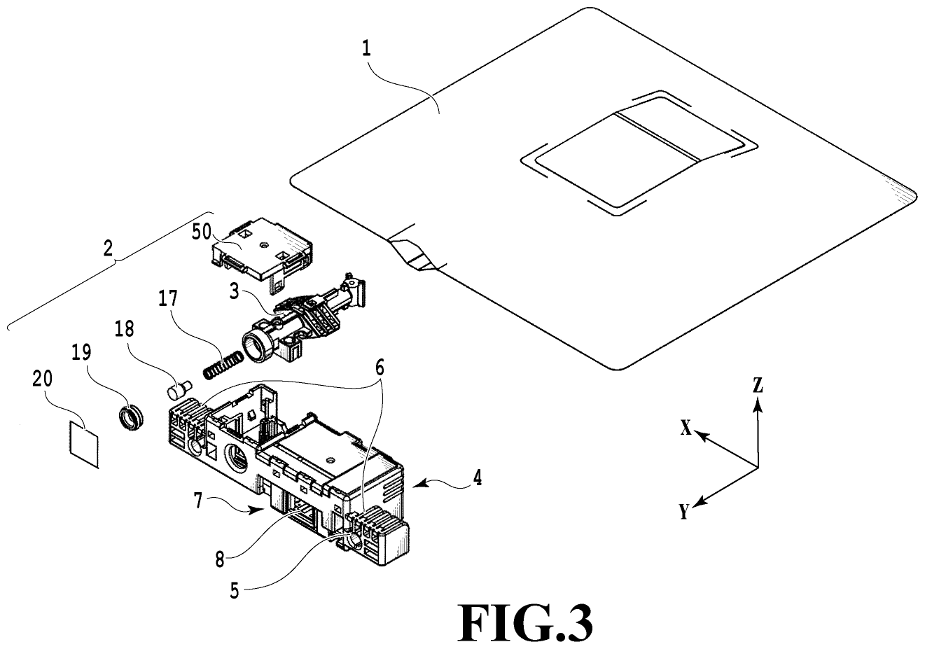

FIG. 2 is a perspective view schematically illustrating a configuration of the liquid storage container 200 of the present disclosure, and FIG. 3 is an exploded perspective view of the liquid storage container 200.

As illustrated in FIG. 2, the liquid storage container 200 is mainly formed of a liquid storage portion 1 storing the liquid (ink and the like) and a liquid transfer unit 2. Additionally, as illustrated in FIG. 3, the liquid transfer unit 2 is formed of an adopter component 4 and a spout 3.

The adopter component 4 is a component having a structure including a positioning hole 5 to perform positioning in a case of mounting into the liquid ejection apparatus 100, a mechanical ID 6, and the like, and a circuit board 7 is assembled. In the circuit board 7, an IC storing information such as color information, material, and an ink amount of the liquid stored in the liquid storage container 200, which is the ink W, for example, is implemented, and a contact 8 is formed. In a mounting state in which the liquid storage container 200 is mounted in a mounting portion of the liquid supply unit 105, the contact 8 of the circuit board 7 is put in contact with a connector provided to the mounting portion, and conduction is made. Thus, the above-described information recorded in the IC can be read out to a liquid ejection apparatus 100 side. The adopter component 4 is a component separated from the spout 3, and thus it is unnecessary to consider the ink-wet performance, the thermal welding property, and the like required for the spout 3. For this reason, it is possible to use polyethylene terephthalate, polyamide, and the like having a high impact resistance as a material of the adopter component 4. The spout 3 and the adopter component 4 may be fixed and assembled with each other indirectly by a snap-fit or thermal welding or by a spout fixing component 50. According to the needs, the adopter component 4 may be molded as an integral component with the spout 3.

The liquid storage portion 1 may be filled with the liquid (ink W) to store the liquid (ink W, omitted in the drawing) therein. The liquid storage portion 1 is formed by making a flexible film into a bag shape by thermal welding and the like. The shape of the liquid storage portion 1 is not particularly limited as long as it is substantially flat in a case where the liquid (ink W) is used up; however, a pillow type, a three-side type, a gusset type, and the like are desirable. The flexible film is not particularly limited as long as it can store the liquid (ink W). For example, the flexible film may be a film of a lamination type. For example, as an inner side of the liquid storage portion 1, thermoplastic resin such as polyethylene, for example, that has the ink-wet performance against the liquid (ink W) and excellent thermal welding property can be used. Additionally, as an outer side of the liquid storage portion 1, a flexible film including a gas barrier layer such as aluminum, for example, that has low gas transmission property can be used. Thus, the liquid storage portion 1 may be a portion that includes an inner layer using the above-described thermoplastic resin as an ink-wet layer and the flexible film including the above-described gas barrier layer on the outer side. In this case, it is possible to laminate the aluminum layer as the film by depositing or laminating. Note that, the flexible film is not necessarily a multi-layer type and may be a single layer type of desired resin in an application in which the gas barrier property is less concerned, for example.

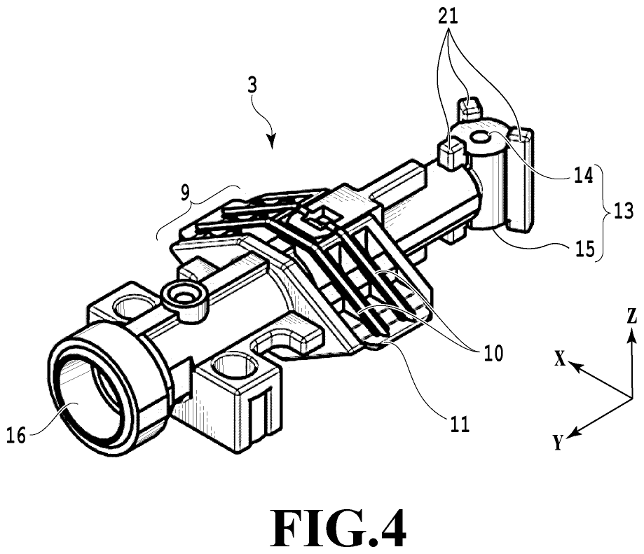

Next, the spout 3 of the liquid storage container 200 of the present disclosure is described in detail with reference to FIGS. 4 to 9. The spout 3 is configured to supply the liquid (ink W) in the liquid storage portion from the liquid storage portion 1 to the liquid ejection head 101.

FIG. 4 is a perspective view of the spout 3, and FIG. 5 is a cross-sectional view of the spout 3. First, the spout 3 is described with reference to FIG. 4. After each component is assembled, the spout 3 is loaded in a mounting portion provided to one side of the flexible liquid storage portion 1 and bonded. The bonding is performed to be airtight with respect to the liquid storage portion 1 by thermocompression bonding, for example. The spout 3 includes a bonding portion 9 to be bonded with the liquid storage portion 1. More specifically, in one embodiment, the bonding portion 9 can be a welding portion that is subjected to the thermocompression bonding. The bonding portion 9 includes a welding rib 10 protruding from a welding surface and spontaneously welded in a case of the thermocompression bonding and a welding wing 11 that is provided to an end portion of the bonding portion 9 to fill a difference in a level from the liquid storage portion 1 by being welded. In one embodiment, the spout 3 can include the welding rib 10 protruding from the welding surface and spontaneously welded in a case of the thermocompression bonding. In one embodiment, the welding rib 10 can be bonded with the liquid storage portion 1 by a method such as the thermocompression bonding. Thus, it is possible to secure high airtightness in the portion subjected to the thermocompression bonding with the liquid storage portion 1. In this case, if the bonding portion 9 and the welding rib 10 are bonded with the liquid storage portion 1 by welding, the spout 3 may be a molded component, and the material thereof has the ink-wet performance against the liquid (ink W) and excellent thermal welding property, molding property, and the like. For example, it is desirable that the material of the bonding portion 9 and the welding rib 10 is olefin resin such as polyethylene and polypropylene. Additionally, for the similar reason, valve 18 (see FIG. 3) assembled into the liquid flow-through hole 12 of the spout 3 (see FIG. 5) may be a component molded by using olefin resin such as polyethylene and polypropylene. Moreover, considering the thermal welding property between the components, in one embodiment, at least welding surfaces of the liquid storage portion 1 and the spout 3 can be the same material. Note that, the above-described component is not necessarily manufactured by mold processing, and another processing method such as a cutting may be selected as a manufacturing method. In addition, it is desirable that the material of a compression spring 17 (see FIG. 3) assembled into the liquid flow-through hole 12 of the spout 3 is stainless steel in view of the ink-wet performance and the corrosion resistance against the liquid (ink W). Furthermore, it is desirable that joint sealing (a sealing member) 19 (see FIG. 3) is a rubber material or thermoplastic elastomer in view of also the ink-wet performance and the corrosion resistance against the liquid (ink W). For example, the material of the rubber material may be Ethylene Propylene Diene Monomer rubber (EPDM), Hydrogenated Nitrile Butadiene Rubber (H-NBR), and the like.

A liquid suction port 13 includes a first liquid suction port 14 opening in the +Z direction (the opposite-of-gravity side) and a second liquid suction port 15 opening in the −Z direction (the gravity side), and the first liquid suction port 14 is arranged to be positioned on a +Z side of the second liquid suction port 15. That is, the above-described first liquid suction port opens in the opposite direction (the +Z direction, the opposite-of-gravity side) of the direction of the gravity in the above-described spout, and the above-described second liquid suction port opens in the direction of the gravity (the −Z direction, the gravity side) in the above-described spout.

The compression spring 17, the valve 18, and the joint sealing 19 are inserted in the liquid flow-through hole 12 of the spout 3 (see FIG. 3). The valve 18 is biased and abutted to the joint sealing 19 constantly by the compression spring 17. The joint sealing 19 is fixed to the liquid flow-through hole 12 by a known method such as rubber lining, bonding, and welding of a retaining component to an outer periphery. With the above-described fixation of the joint sealing 19, the valve 18 is installed so as not to be removed even with biasing force from the compression spring 17. With this configuration, in a case where force of movement in the −Y direction that warps the compression spring 17 acts on the valve 18, an opening state of a channel of the liquid (ink W) is obtained. On the other hand, in a case where the force moving in the +Y direction acts on the valve 18, the channel of the liquid (ink W) is blocked, and it is possible to inhibit flow-in of the air into the liquid storage portion 1 and leakage of the liquid (ink W). In this case, in order to further reduce the possibility of the flow-in of the air and the unexpected leakage or backflow of the liquid, a configuration that prevents the flow-in of the liquid from the outside of the liquid storage container 200 to the inside of the liquid storage portion 1 can be added. For example, in addition to the valve 18, in the liquid flow-through hole 12, a configuration to further provide a check valve on a liquid storage portion 1 side may be additionally adopted. Additionally, for the purpose of improving the gas barrier property before mounting the liquid storage container 200, preventing the foreign matter inclusion from the outside, and the like, the following configuration may be adopted. That is, a configuration in which another member (for example, an opening film 20) such as a film is welded on the opening of the liquid flow-through hole 12 such that the film is broken through by an ink needle and the like in a case where the liquid storage container is mounted in the liquid ejection apparatus.

The spout 3 includes at least a configuration as illustrated in FIG. 5. That is, the spout 3 includes the liquid suction port 13 that opens to be able to suck the liquid (ink W) from the inside of the liquid storage portion 1. Additionally, the spout 3 also includes the liquid flow-through hole 12 through which the sucked liquid passes and a liquid supply port 16 that opens to be able to supply the liquid to the liquid ejection apparatus 100. As illustrated in FIG. 5, the liquid suction port 13 is provided in the gravity direction (the Z-axis direction). Moreover, as illustrated in FIG. 5, the liquid flow-through hole 12 and the liquid supply port 16 are formed along the Y-axis direction of the spout 3. As illustrated in FIG. 5, the Y-axis direction is a direction along a longitudinal direction of the spout 3. In the present specification, an axis along the Y-axis direction (the longitudinal direction of the spout 3) is referred to as “main axis of the spout 3” (in the present specification, also referred to as “main axis,” simply), and a direction of the main axis (the Y-axis direction) is “main axis direction” of the spout. The main axis direction of the spout 3 (the longitudinal direction of the spout 3) is a direction orthogonal to the gravity direction (the Z-axis direction) that is a direction in which the liquid suction port 13 is provided.

According to the above-described configuration, in a case where a precipitation component in the liquid (ink W) inside the liquid storage portion 1 is precipitated, a low density portion (a +Z direction side) of the precipitation component in the liquid (ink W) is sucked from the first liquid suction port 14. Additionally, a high density portion (a −Z direction side) of the precipitation component is sucked from the second liquid suction port 15. In a case of the above-described suction, the low density portion of the precipitation component and the high density portion of the precipitation component are sucked simultaneously, and the corresponding liquids (ink W) are mixed with each other in the liquid flow-through hole 12 and supplied to the liquid ejection apparatus 100 as the liquid (ink W) at a uniform density. Thus, it is possible to suppress a variation in shades of a character, a sign, an image, and so on formed on the recording sheet 107 and a failure of the liquid ejection head 101 that are caused by supplying the liquid at an excessively high density or the liquid at an excessively low density to the liquid ejection apparatus 100.

In the above-described configuration, in order to maintain the density of the liquid (ink W) supplied to the liquid ejection apparatus 100 uniform, the high-density portion and the low-density portion of the precipitation component in the liquid (ink W) in which the precipitation component is precipitated need to be sucked and mixed at a proper flow rate ratio. Accordingly, it is desirable to properly determine a relationship between a flow-in resistance R1 of the liquid in the first liquid suction port 14 and a flow-in resistance R2 of the liquid in the second liquid suction port 15 according to the characteristics such as ease of the precipitation of the precipitation component in the liquid (ink W) or a viscosity of the liquid (ink W). That is, in order to maintain the density of the liquid supplied to the liquid ejection apparatus 100 uniform, the relationship between the flow-in resistance R1 and the flow-in resistance R2 is properly determined. For example, in the liquid having a general precipitation component that has a high viscosity on a lower side in the liquid storage portion 1 (the −Z direction) and a low viscosity on an upper side (the +Z direction), the relationship between the flow-in resistance R1 and the flow-in resistance R2 can be a relationship indicated by (Expression 1) below.

$$R 1 \geq R 2 \qquad ( Expression 1 )$$

In one embodiment, a specific relationship of shapes between the first liquid suction port 14 and second liquid suction port 15 to implement the above expression can have a relationship indicated by (Expression 2) below, wherein an opening area of the first liquid suction port 14 is A1, and an opening area of the second liquid suction port 15 is A2.

$$A 2 \geq A 1 \qquad ( Expression 2 )$$

In addition, it is desirable to properly determine the opening area A1 of the first liquid suction port 14 and the opening area A2 of the second liquid suction port 15 according to a distribution of the density or the viscosity of the liquid (ink W) in which the precipitation component is precipitated inside the liquid storage portion 1. For example, it is possible to exemplify the following case as a specific example of a case where the liquid is the ink W. In a state in which the liquid storage container 200 has been left for a sufficient period of time, and the precipitation of the ink W has reached the limit, 1 ml of the ink W in the liquid storage portion 1 was collected from the highest position (the uppermost position in the liquid storage portion 1 in the +Z direction). The density of the precipitation component collected in this position (a percentage if the density in the uniform state is 100%) was 56%, and the viscosity was 5.9 mPa·s. Additionally, the density of the precipitation component of 1 ml of the ink W in the liquid storage portion 1 collected from the lowest position (the lowermost position in the liquid storage portion in the −Z direction) was 199%, and the viscosity was 7.6 mPa·s. In this case, a relationship between the opening area A1 and the opening area A2 may be a relationship indicated by (Expression 3) below.

$$A 1 \div A 2 = 0.51 \qquad ( Expression 3 )$$

Note that, a state after the precipitation of the precipitation component, that is, the above-described relationships between R1 and R2 and A1 and A2 are heavily dependent on a type of the liquid such as the ink W. For this reason, as for the optimum relationship between the flow-in resistances R1 and R2 and an opening ratio between the opening areas A1 and A2, it is desirable to obtain an optimum value according to the type of the liquid stored in the liquid storage portion 1.

With the above-described configuration, it is possible to suck a portion of the liquid (ink W) further spontaneously, the portion having a higher density or viscosity of the liquid (ink W) due to precipitation of the precipitation component and becoming difficult to be sucked. Therefore, it is possible to make the density of the liquid (ink W) supplied to the liquid ejection head more uniform.

In one embodiment, as illustrated in FIG. 4, the opening of the liquid suction port 13 can have a simple circular hole shape (a circular shape). In addition, as illustrated in FIG. 5, the centers of the first liquid suction port 14 and the second liquid suction port 15 viewed from the Z-axis direction may be aligned with the center axis of the gravity direction. That is, in one embodiment, the center of the above-described first liquid suction port and the center of the above-described second liquid suction port can be on the same center axis. Thus, a structure of the channel is simple. Thus, it is possible to greatly change the flow-in resistance R1 of the liquid in the first liquid suction port 14 and the flow-in resistance R2 of the liquid in the second liquid suction port 15. Specifically, it is possible to greatly change the flow-in resistances R1 and R2 only by changing the opening area A1 of the first liquid suction port 14 and the opening area A2 of the second liquid suction port 15 according to the characteristics of the liquid (ink W) at a stage of designing. This makes it possible to easily adjust the flow-in resistances R1 and R2 according to the liquid (ink W) stored in the liquid storage portion.

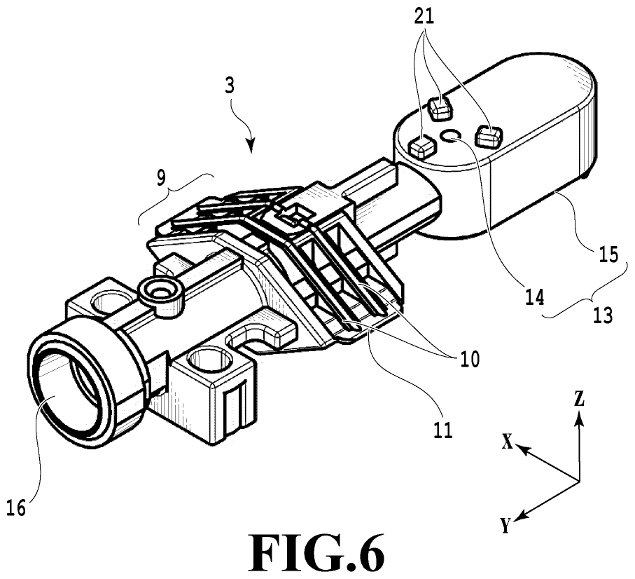

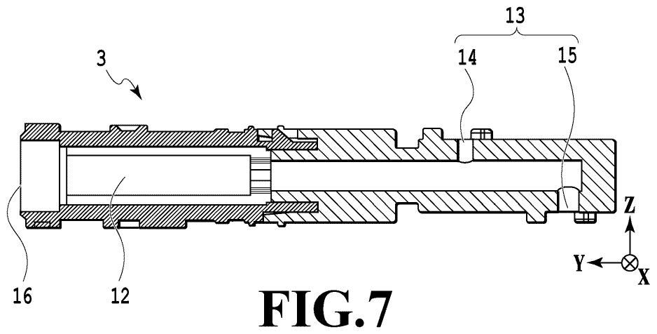

Next, with reference to FIGS. 6 and 7, a mode in which the centers of the first liquid suction port 14 and the second liquid suction port 15 viewed from the +Z direction are not aligned with each other is considered as a reference example of the present disclosure.

In the present embodiment (the reference example), as illustrated in FIGS. 6 and 7, a mode in which the centers of the first liquid suction port 14 and the second liquid suction port 15 viewed from the +Z direction as illustrated in FIG. 6 (and the −X direction in a case of FIG. 7) are not aligned with each other. A state that is, in the above-described mode of the liquid suction port 13, a state immediately after starting to supply the liquid from a state in which the precipitation component of the liquid (ink W) is precipitated after the liquid storage container 200 has been left for a long period of time is considered. In this state, the liquid at a low density that is sucked from the first liquid suction port 14 near the liquid supply port 16 and the liquid at a uniform density in the liquid flow-through hole 12 are mixed with each other. In the above-described state, there is a possibility that the liquid at a low density is supplied to the liquid ejection apparatus 100 temporarily. Also in a case where the positional relationship between the first liquid suction port 14 and the second liquid suction port 15 is opposite, for the similar reason, there is a possibility that the liquid at a high density is supplied to the liquid ejection apparatus 100 temporarily.

Therefore, in the present embodiment, the mode of the liquid suction port 13 is desirably the mode of the liquid suction port as illustrated in FIGS. 4 and 5. Also in the liquid ejection apparatus of the present disclosure, it is possible to use the liquid storage container as illustrated in FIGS. 4 and 5 as the liquid storage container 200 of the present disclosure. With the above-described mode, the liquid at a low density that is sucked from the first liquid suction port 14 and the liquid at a high density that is sucked from the second liquid suction port 15 are immediately converged and mixed with each other, and it is possible to constantly supply the liquid at a uniform density.

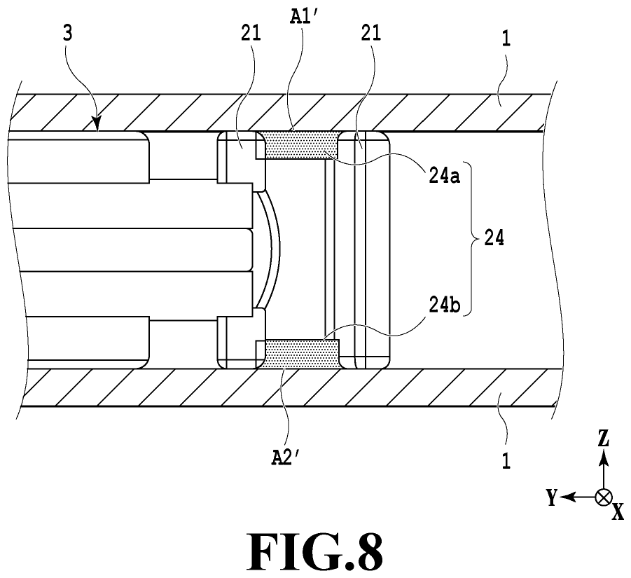

A choking prevention rib 21 is arranged around the liquid suction port 13. In one embodiment, the choking prevention rib 21 can be arranged to prevent the liquid storage portion from being closely attached to the liquid suction port 13 and closing the opening. For example, it is possible to arrange the choking prevention rib 21 to be close to or adjacent to the liquid suction port 13 to satisfy a relationship of (Expression 4) or (Expression 5) described later. FIG. 8 is a diagram of the spout 3 viewed from the −X direction in a case where the film forming the liquid storage portion 1 is put in contact with the spout. In a case where the flexible film forming the liquid storage portion 1 is closely attached to the spout 3 due to deformation, there is a possibility of closing the liquid suction port 13 and inhibiting the supply of the liquid (ink W). However, with the choking prevention rib 21 being provided, in a case where the liquid storage portion 1 is closely attached to the spout 3, a pseudo liquid suction port 24 is formed between the liquid storage portion 1 and the spout 3, and it is possible to suppress the inhibition of the supply of the liquid (ink W).

As illustrated in FIG. 8, the pseudo liquid suction port 24 includes a first pseudo liquid suction port 24a on a first liquid suction port 14 side and a second pseudo liquid suction port 24b on a second liquid suction port 15 side. The first pseudo liquid suction port 24a has an opening area A1′, and the second pseudo liquid suction port 24b has an opening area A2′. In the present embodiment, the opening area of the pseudo liquid suction port 24 is desirablely great as much as possible. In particular, a relationship between the opening area A1 of the first liquid suction port 14 and the opening area A1′ of the first pseudo liquid suction port 24a formed around the first liquid suction port 14 can have a relationship indicated by (Expression 4) below.

$$A {1}^{′} > 3 \times A 1 \qquad ( Expression 4 )$$

Likewise, a relationship between the opening area A2 of the second liquid suction port 15 and the opening area A2′ of the second pseudo liquid suction port 24b formed around the second liquid suction port 15 also can have a relationship indicated by (Expression 5) below.

$$A {2}^{′} > 3 \times A 2 \qquad ( Expression 5 )$$

In a case where the liquid storage portion 1 is closely attached to the spout 3, the first pseudo liquid suction port 24a and the second pseudo liquid suction port 24b may cause a flow resistance. In this case, it may be impossible to suck the high-density portion and the low-density portion of the precipitation component in the liquid (ink W) according to the flow rate ratio determined by the opening areas of the first liquid suction port 14 and the second liquid suction port 15. Even in the above-described case, with a configuration satisfying the above-described relationships of (Expression 4) and (Expression 5), the flow resistance caused by the first pseudo liquid suction port 24a and the second pseudo liquid suction port 24b may be sufficiently small. Thus, it is possible to suppress a great change in the flow rate ratio in a case of sucking the high-density portion and the low-density portion of the precipitation component in the liquid (ink W). Accordingly, it is possible to stably supply the liquid (ink W) at a uniform density regardless of whether the liquid storage portion 1 is closely attached.

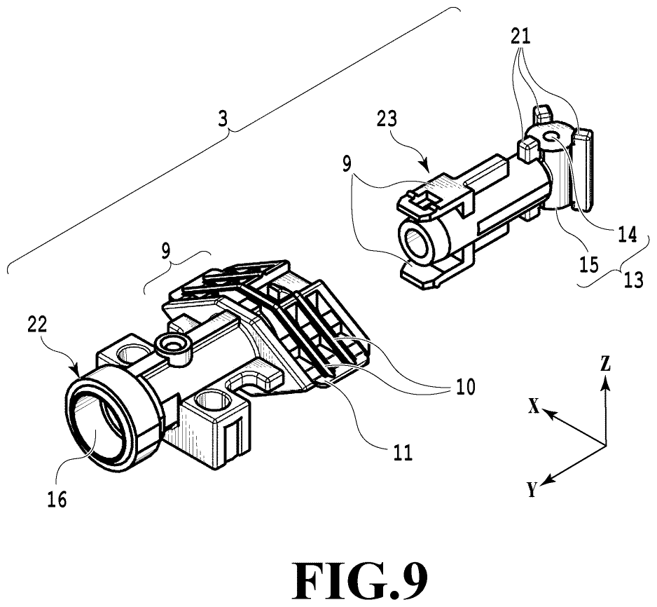

Additionally, in the present embodiment, the spout 3 can be formed such that a liquid supply unit 22 forming the liquid supply port 16 and a liquid suction unit 23 forming the liquid suction port 13 are separate bodies as illustrated in FIG. 9. Alternatively, in the present embodiment, the liquid supply unit 22 forming the liquid supply port 16 and the liquid suction unit 23 forming the liquid suction port 13 may be integrally formed.

In a case where the liquid supply unit 22 forming the liquid supply port 16 and the liquid suction unit 23 forming the liquid suction port 13 are formed as separate bodies, the liquid supply unit 22 and the liquid suction unit 23 are connected to each other along the main axis of the spout (see FIG. 5) (along the longitudinal direction). Thus, for instance, in a case where multiple liquid storage containers 200 are designed for multiple different types of liquids (ink W), only the liquid suction unit 23 can be replaced according to the precipitation characteristics of the component of the liquid, and others can be used as common components. With the above-described configuration, it is possible to reduce the design cost and the manufacturing cost. In the above-described configuration, the same material is used for the liquid supply unit 22 and the liquid suction unit 23, and it is also possible to provide the bonding portion 9 (in a case of the thermocompression bonding, the welding portion) for bonding with the liquid storage portion 1 to both the components. Thus, it is possible to bond both the liquid supply unit 22 and liquid suction unit 23 to the liquid storage portion 1 in a case of bonding the spout 3 and the liquid storage portion 1, and it is possible to suppress separation of the two components, the liquid supply unit 22 and the liquid suction unit 23, due to an impact and the like from the outside. Alternatively, in the present embodiment, a configuration of using different materials for the liquid supply unit 22 and the liquid suction unit 23 and providing an additional function to the spout 3 may be applied. For example, the liquid supply unit 22 may be made of polyethylene or polypropylene that can be welded to the liquid storage portion 1 by the thermocompression bonding and the like, and the liquid suction unit 23 may be made of a rubber material and the like that are deformable according to the crumpling of the liquid storage portion 1. With the above-described configuration, it is possible to reduce the liquid that remains inside the liquid storage portion 1 in a case where there is a small amount of the remaining liquid in the liquid storage portion 1, and the liquid suction unit 23 is deformed according to the crumpling of the liquid storage portion 1.

In a case where the spout 3 is formed of the separate components, the liquid supply unit 22 and the liquid suction unit 23, the liquid suction unit 23 can be formed so as to fit within the inner side of an outer shape (a shape of an outer frame portion) of the bonding portion 9 in a case where the spout 3 is viewed from the main axis direction that is the longitudinal direction of the spout 3, which is particularly the −Y direction. In addition, in the above-described configuration, it is also possible to additionally provide the bonding portion (in a case of bonding by the thermocompression bonding, the welding portion) for bonding with the liquid storage portion 1 in a portion corresponding to the liquid suction unit.

### Second Embodiment

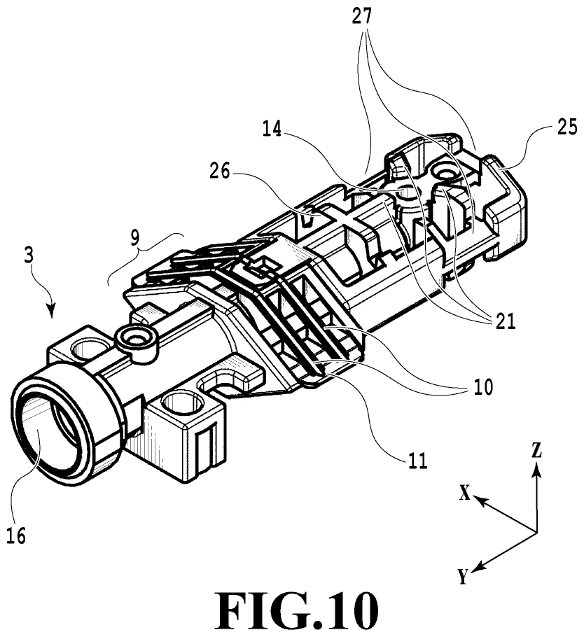

The liquid storage container 200 that is a second embodiment of the present disclosure is described with reference to FIGS. 10 to 13.

As with the first embodiment, the liquid storage container 200 of the second embodiment is the liquid storage container 200 in a mode that is formed of the liquid storage portion 1 and the liquid transfer unit 2 including the adopter component 4 and the spout 3. In the following descriptions, a shape of the spout 3 that is a different point from the first embodiment is mainly described in detail.

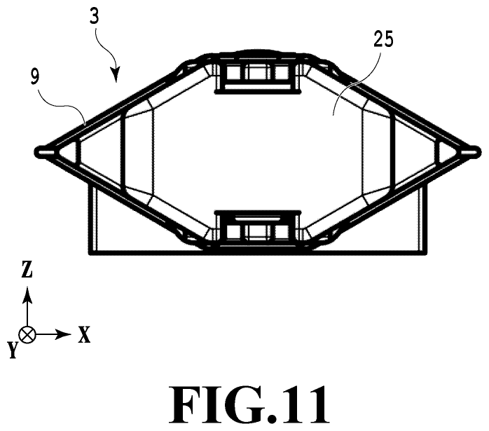

FIG. 10 is a perspective view of the spout 3 in the present embodiment. Additionally, FIG. 11 is a diagram of the spout 3 in FIG. 10 that is viewed from the −Y direction. In the spout 3 of the present embodiment, a frame 25 is provided around the liquid suction port 13. As illustrated in FIG. 11, the frame 25 may be formed to be fitted within the inner side of the outer shape (the outer frame portion) of the bonding portion 9 in a case where the spout 3 is viewed from the −Y direction (in a case where the spout 3 is viewed from the main axis direction that is the longitudinal direction of the spout 3). Additionally, it is possible to additionally provide a connection rib 26 between a periphery of the liquid suction port 13 and the frame 25. In this case, the frame 25 is connected to the connection rib 26 and reinforced. The connection rib 26 may be formed to fill a space between the periphery of the liquid suction port 13 and the frame 25. In the present embodiment, from the functional aspect, it is desirable to fill the entire space between the frame 25 and the liquid suction port 13. However, in a case where the component of the spout 3 is formed by injection molding, in general, the thicker the component, the higher the possibility of warping or a sink mark. Additionally, it is also necessary to make the thickness uniform in the same component. Accordingly, it is desirable to arrange the connection rib 26 having a volume as great as possible, as many as possible, to fill the space between the periphery of the liquid suction port 13 and the frame 25. As a specific example in the present embodiment, in a case where the connection rib 26 is molded as a molding product by using polyethylene (PE), the thickness of the rib is 5 mm or smaller, the component consistently has a thickness of about 1.5 mm because of the restriction of size, and the connection rib 26 is molded as many as possible.

According to the above-described configuration, it is possible to reduce the amount of the liquid remaining in the liquid storage container 200 by filling the space formed by the spout 3 and the liquid storage portion 1 by the structure like the connection rib 26 in a case of using up the liquid in the liquid storage portion 1.

As illustrated in FIG. 10, a notch 27 can be provided to the frame 25. In this case, an opening of the notch 27 can be made as great as possible and be provided in multiple portions in the frame 25. For example, in one embodiment, the notch 27 may have a size of 3.5 mm² or greater (for example, 1 mm ×3.5 mm) as an opening area thereof.

Thus, even in a case where the liquid storage portion 1 is closely attached to the spout 3, it is possible to suppress disruption of the channel of the liquid to the liquid suction port 13 or a great flow-in resistance caused by the notch 27. Accordingly, it is possible to suppress a failure of sucking the liquid from the liquid suction port 13 even though the liquid remains in the liquid storage container 200.

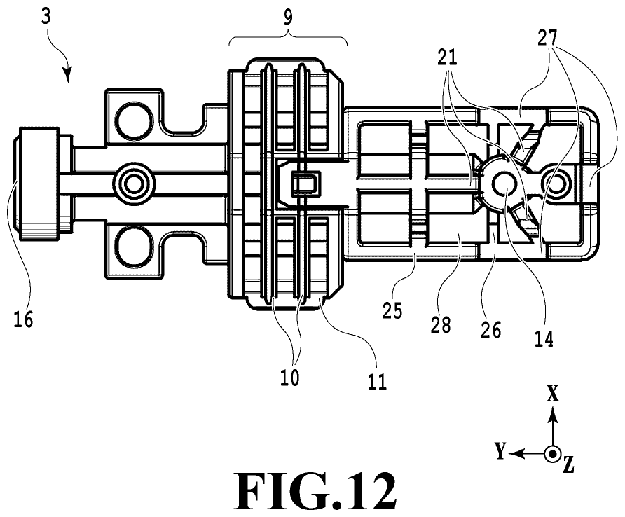

Next, another modification of the present embodiment is described with reference to FIG. 12. FIG. 12 is a diagram of the spout 3 that is viewed from the +Z direction. In the present modification, a through hole 28 can be provided that penetrates through the space between the liquid suction port 13 and the frame 25 in the Z-axis direction (the gravity direction). In this case, if there is no through hole, the precipitation component of the liquid (ink W) may be accumulated in a region between the first liquid suction port 14 and the second liquid suction port 15 within a region surrounded by the frame 25. In addition, in the above-described case, there is a possibility that the high-density portion is sucked into the first liquid suction port 14 that is originally designed to suck the low-density portion. With the above-described through hole 28 being provided, it is possible to suppress the above-described possibility. Accordingly, it is possible to supply the liquid at a uniform density to the liquid ejection head.

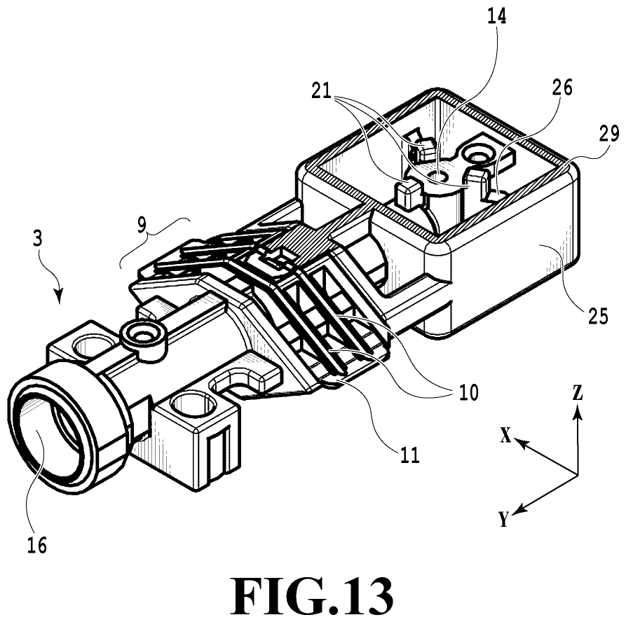

It is also possible to provide a filter function to the spout 3. As a specific example, as illustrated in FIG. 13, there is a configuration in which a filter bonding portion 29 indicated by hatching is provided on the frame 25 to put a mesh filter thereon. Thus, it is possible to suppress the supply of an aggregated component in the liquid (ink W) or unexpected mixed impurities to the liquid ejection head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the liquid storage container of the present disclosure, even in a case where the density or the viscosity of the liquid stored in the liquid storage portion is changed, it is possible to supply the liquid at a uniform density. Additionally, at the same time, it is possible to downsize the structure provided in the liquid storage portion, and it is possible to reduce the liquid remaining in the liquid storage container in a case of using up the liquid.

This application claims the benefit of Japanese Patent Application No. 2025-025869, filed Feb. 20, 2025, which is hereby incorporated by reference herein in its entirety.

What is claimed is:

1. A liquid storage container, comprising:
a flexible liquid storage portion storing a liquid including a precipitation component; and
a spout mounted in the liquid storage portion, wherein
the spout includes at least a first liquid suction port and a second liquid suction port,
as for the first liquid suction port and the second liquid suction port, the center of the first liquid suction port and the center of the second liquid suction port are on the same center axis,
the first liquid suction port opens in the opposite direction of a direction of gravity in the spout,
the second liquid suction port opens in the direction of the gravity in the spout, and
a relationship of A2≥A1 is satisfied, where an opening area of the first liquid suction port is A1, and an opening area of the second liquid suction port is A2.

2. The liquid storage container according to claim 1, wherein
an opening of each of the first liquid suction port and the second liquid suction port is a circular shape.

3. The liquid storage container according to claim 1, wherein
the spout includes a choking prevention rib around each of the first liquid suction port and the second liquid suction port.

4. The liquid storage container according to claim 1, wherein
the spout includes a liquid supply unit including a bonding portion to be bonded with the liquid storage portion and a liquid suction unit including the first liquid suction port and the second liquid suction port,
the liquid supply unit and the liquid suction unit are formed as different components,
the liquid supply unit and the liquid suction unit are connected to each other along a main axis of the spout in a longitudinal direction, and
an outer shape of the liquid suction unit is fitted within an inner side of an outer shape of the bonding portion while viewing from a main axis direction of the spout.

5. The liquid storage container according to claim 4, wherein the liquid supply unit and the liquid suction unit are integrally formed.

6. The liquid storage container according to claim 4, wherein
the liquid suction unit further includes a bonding portion to be bonded with the liquid storage portion.

7. The liquid storage container according to claim 1, wherein
the spout further includes a frame around the first liquid suction port and the second liquid suction port.

8. The liquid storage container according to claim 4, wherein
the spout further includes a frame around the first liquid suction port and the second liquid suction port, and
the frame is fitted within the inner side of the outer shape of the bonding portion of the liquid supply unit while viewing from the main axis direction of the spout.

9. The liquid storage container according to claim 7, wherein the frame further includes a connection rib.

10. The liquid storage container according to claim 7, wherein
the frame includes a through hole that penetrates through the frame in a gravity direction.

11. The liquid storage container according to claim 7, wherein the frame further includes a filter.
